(19) United States
(12) Patent Application Publication
(10) Pub. No.: US 2013/0138463 A1
(43) Pub. Date: May 30, 2013

(54) SCHEDULING WORKERS

(71) Applicant: Feridoon Amini, Frisco, TX (US)

(72) Inventor: Feridoon Amini, Frisco, TX (US)

(21) Appl. No.: 13/308,204

(22) Filed: Nov. 30, 2011

(51) Int. Cl. G06Q 10/06

(52) U.S. Cl. 705/7.14

(57) ABSTRACT

For scheduling workers, a management module generates a business event in response to receiving a scheduling event. The business event comprises a skill requirement and a time requirement. A communication module communicates a worker request to a worker contact address of at least one worker profile if the at least one worker profile matches the business event. The worker request comprises the skill requirement and the time requirement. In addition, the communication receives at least one bid for the worker request from the worker contact address in response to the worker request.

### BACKGROUND

1. Field

The subject matter disclosed herein relates to scheduling and more particularly relates to scheduling workers.

2. Description of the Related Art

Businesses rely on workers to perform functions. Circumstances often necessitate the scheduling of workers.

### BRIEF SUMMARY

A method for scheduling workers is disclosed. The method comprises generating a business event in response to receiving a scheduling event. The business event comprises a skill requirement and a time requirement. The method further communicates a worker request to a worker contact address of at least one worker profile if the at least one worker profile matches the business event. The worker request comprises the skill requirement and the time requirement. In addition, the method receives at least one bid for the worker request from the worker contact address in response to the worker request. An apparatus and computer program product also perform the functions of the method.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a scheduling environment;

FIG. 2 is a schematic block diagram illustrating one embodiment of a business event;

FIG. 3 is a schematic block diagram illustrating one embodiment of a worker profile;

FIG. 4 is a schematic block diagram illustrating one embodiment of a worker request;

FIG. 5 is a schematic block diagram illustrating one embodiment of a bid;

FIG. 6 is a schematic block diagram illustrating one embodiment of a computer;

FIG. 7 is a schematic block diagram illustrating one embodiment of a scheduling apparatus;

FIG. 8A is a schematic flow chart diagram illustrating one embodiment of a scheduling method;

FIG. 8B is a schematic flow chart diagram illustrating alternate embodiment of a scheduling method;

FIGS. 9A-F are schematic block diagrams illustrating one embodiment of a scheduling cycle; and

FIGS. 10A-C are schematic block diagrams illustrating one alternate embodiment of a scheduling cycle.

### DETAILED DESCRIPTION OF THE INVENTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

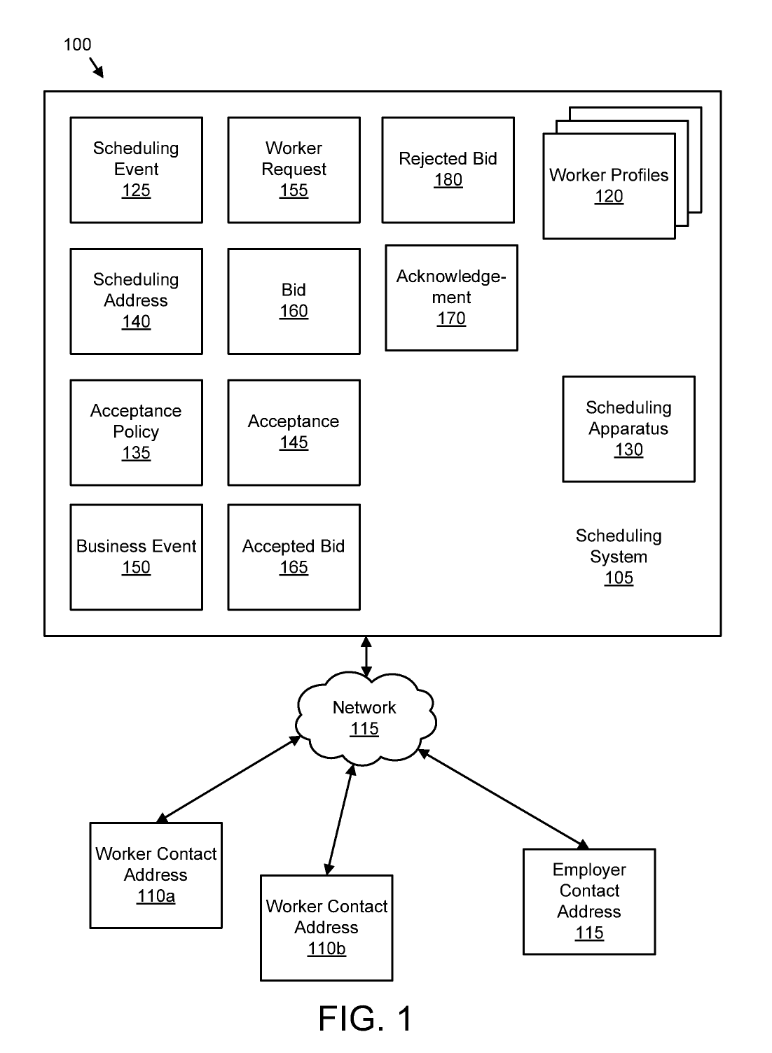

FIG. 1 is a schematic block diagram illustrating one embodiment of a scheduling environment 100. The scheduling environment 100 includes a scheduling system 105, a network 115, one or more worker contract addresses 110, and the employer contract address 115. The scheduling system 105 may include a scheduling event 125, a scheduling apparatus 130, one or more worker profiles 120, an acceptance policy 135, and a scheduling address 140. In addition, the scheduling system 105 includes of business event 150, a worker request 155, a bid 160, an acceptance 145, an accepted bid 165, a rejected bid 180, and an acknowledgement 170.

The network 115 may be the Internet, a wide area network, a local area network, a wireless network, a cellular telephone network, or the like. The worker contact address 110, the employer contact address 115, and the scheduling address 140 may be addresses for a channel that communicates through the network 115. The channel may be at least one of an Internet channel, a Short Message Service (SMS) channel, a telephonic channel, a mobile telephone channel, and an email channel. In one embodiment, the scheduling address 140, worker contact addresses 110, and employer contact address 115 each comprise a plurality of addresses. For example, the scheduling address 140 may include an e-mail address, a Universal Resource Locator (URL) address, and SMS number address, or the like.

The worker contact address 110 and the employer contact address 115 may be hosted on electronic devices such as cellular telephones, personal digital assistants (PDA), smart phones, computers, computer tablets, and the like. The scheduling address 140 may be hosted by the scheduling system 105.

For example, a first worker contact address 110a may be the telephone number for a mobile telephone. Messages for the first worker contact address 110a may be communicated through a mobile telephone channel to the mobile telephone. Alternatively, the employer contact address 115 may be an e-mail address. Messages for the employer contact address 115 may be communicated through an e-mail channel.

The scheduling event 125 may be an event that necessitates the scheduling of the worker. The business event 150 may be generated in response to the scheduling event 125. In one embodiment, the business event 150 is generated automatically in response to the scheduling event 125. The scheduling system 105 may communicate the worker request 155 to the worker contact address 110 in response to the business event 150. The scheduling system 150 may further receive the bid 160 from the worker contact address 110 in response to the worker request 155. The scheduling system 105 may use the acceptance policy 135 to determine if the bid 160 is accepted.

In one embodiment, the scheduling system 150 communicates the bid 160 to the employer contact address 115 and receives an acceptance 145 from the employer contact address 115. If the bid 160 is accepted, the bid 160 is stored as an accepted bid 165. If the bid 160 is rejected, the bid 160 is stored as a rejected bid 180. The scheduling system 150 may communicate the acceptance 145 to the worker contact address 110 corresponding to the accepted bid 165. In addition, the scheduling system 150 may receive an acknowledgment 170 from the worker contact address 110.

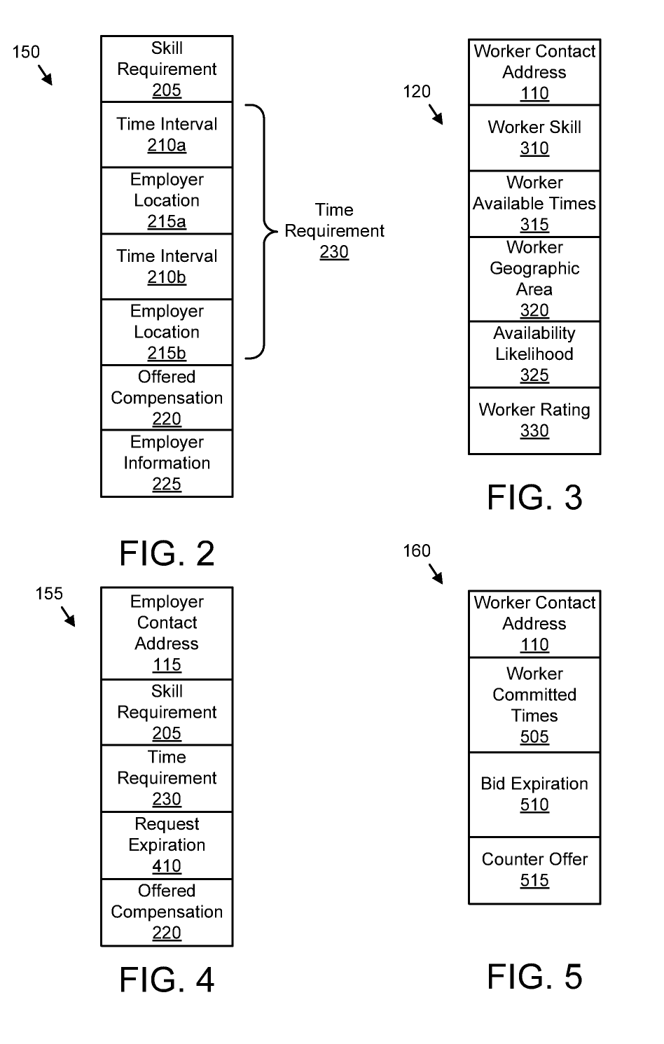

FIG. 2 is a schematic block diagram illustrating one embodiment of a business event 150 of FIG. 1. The business event 150 is the business event of FIG. 1. The business event 150 may be generated in response to the scheduling event 125 of FIG. 1. The description of the business event 150 refers to elements of FIG. 1, like numbers referring to like elements. The business event 150 includes a skill requirement 205 and a time requirement 230. The time requirement 230 may include one or more pairs of time intervals 210 and employer locations 215. The time requirement 230 may be a fractional portion of a work period, the work period selected from the group consisting of at least one work day, at least one work week, and at least one work month. In addition, the business event 150 may include an offered compensation 220 and employer information 225. In one embodiment, the employer information 225 includes the employer contact address 115.

The skill requirement 205 may comprise a minimum educational degree requirement, a certification, specialty identification, or the like. The minimum educational degree requirement may specify a minimum educational degree from an accredited institution. The certification may comprise required specialized training, governmental certification, certification by professional oversight body, or the like. The specialty identification may specify a required particular skill and/or talent.

Each time interval 210 may include one or more start time and end time pairs. For example, a time interval 210 may be 8 a.m. to 5 p.m. The employer location 215 may specify the location where work will be performed. The employer location 215 may be an address, a Global Position System (GPS) coordinate, or the like.

The offered compensation 220 may be an amount of remuneration for a worker performing the skill requirement 205 for the time requirement 230. The offered compensation 220 may be an hourly rate, a flat rate, or combinations thereof. The employer information 225 may include the employer contact address 115, additional contact information such as a telephone number, the name of the employer, and the like. In a certain embodiment, the employer information 225 includes an employer rating. The employer rating may comprise one or more evaluations from one or more worker contact addresses 110 evaluating each worker's experience with the employer.

FIG. 3 is a schematic block diagram illustrating one embodiment of a worker profile 120. The worker profile 120 is the worker profile 120 of FIG. 1. The description of the worker profile 120 refers to elements of FIGS. 1-2, like numbers referring to like elements. The worker profile 120 stores information describing a worker. The worker profile 120 may be created by an employer. Alternatively, the worker profile 120 may be entered into the scheduling system 105 by the worker as part of a job application process. The worker profile 120 includes the worker contact address 110, a worker skill 310, worker available times 315, a worker geographic area 320, an availability likelihood 325, and a worker rating. The worker skill 310 may comprise one or more educational degrees, one or more certifications, one or more specialty identifications, and the like.

The worker available times 315 may identify one or more time intervals during which the worker is available for employment. The worker available times 315 may identify days of the week, hours of the day, months of the year, and the like during which the worker is typically available for employment.

The worker contact address 110 is an address that will be used to communicate worker requests 155 and acknowledgements 170 to a worker and receive bids 160 from the worker. The worker geographic area 320 is a physical area within which the worker is available for employment. In one embodiment, the worker geographic area 320 is a distance from a worker location. The worker location may include a home address, a school address, or the like identified by the worker. Alternatively, the worker geographic area 320 may be the area served by a least one specified postal code.

In one embodiment, the availability likelihood 325 is an estimate that the worker of the worker profile 120 will accept a worker request 155. The availability likelihood 325 may be calculated as a number of bids 160 received from the worker divided by a number of worker requests 155 communicated to the worker. The worker rating 330 may indicate satisfaction with the worker's performance. In one embodiment, the worker rating 330 may comprising ratings received from one or more employer contact addresses 115 that indicate employer satisfaction with the worker's performance.

FIG. 4 is a schematic block diagram illustrating one embodiment of a worker request 155. The worker request 155 is the worker request 155 of FIG. 1 and may be communicated to the worker contact address 110 of the worker profile 120 if the worker profile 120 matches the business event 150. The description of the worker request 155 refers to elements of FIGS. 1-3, like numbers referring to like elements. The worker request 155 includes the employer contact address 115 the skill requirements 205, the time requirement 230, a request expiration 410, and the offered compensation 220.

The employer contact address 115, the skill requirement 205, and the time requirement 230 are the employer contact address 115, the skill requirement 205, and the time requirement 230 of FIGS. 1-2. The request expiration 410 may specify a time after which the worker request 155 is no longer valid. For example, the request expiration 410 may specify that the worker request 155 expires in 6:30 a.m. After 6:30 a.m., the worker request 155 is no longer valid. In one embodiment, the worker may be unable to retrieve the worker request 155 from the worker contact address 110 after the time of the request expiration 410. Alternatively, the worker may be unable to respond to the worker request through the worker contact address 110 after the time of the request expiration 410.

FIG. 5 is a schematic block diagram illustrating one embodiment of a bid 160. The bid 160 may be the bid of FIG. 1. The bid 160 may be received from the worker contact address 110 in response to the worker request 155. The description of the bid 160 refers to elements of FIGS. 1-4, like numbers referring to like elements. The bid 160 includes the worker contact address 110, one or more worker committed times 505, a bid expiration 510, and a counter offer 515.

The worker contact address 110 is the worker contact address 110 of FIGS. 1, 3, and 4. The worker committed times 505 may comprise time intervals that fall within the time requirement 230. In one embodiment, the worker committed times 505 encompass all of the time requirement 230. Alternatively, the worker committed times 505 may encompass one or more portions of the time requirement 230.

The bid expiration 510 may specify a time after which the bid 160 is no longer valid. For example, if the bid expiration 510 specifies that the bid 160 expires after 7 p.m., then after 7 p.m. the bid 160 is no longer valid and may no longer be accepted. In one embodiment, the scheduling system 105 may no longer consider the bid 160 after the time of the bid expiration 510.

In one embodiment, the counter offer 515 is a worker requested compensation that is different from the offered compensation 220. For example, a worker may request a higher compensation by including the counter offer 515.

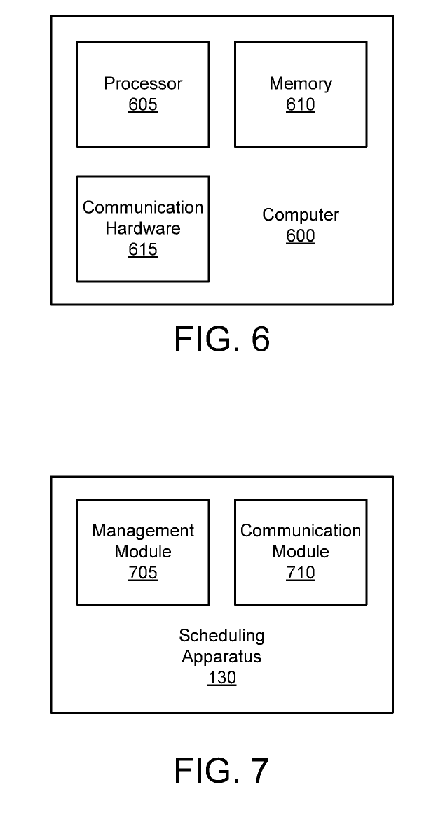

FIG. 6 is a schematic block diagram illustrating one embodiment of a computer 600. The computer 600 may embody the scheduling system 105 FIG. 1. The description of the computer 600 refers to elements of FIGS. 1-5, like numbers referring to like elements. The computer 600 includes a processor 605, memory 610, and communication hardware 615.

The memory 610 may store computer readable program code. The memory 610 may be a semiconductor memory, a hard disk drive, an optical storage device, or the like. In one embodiment, the memory 610 stores the scheduling event 125, business event 150, the worker profile 120, the worker request 155, the bid 160, the accepted bid 165, the rejected bid 180, and the acknowledgement 170. The processor 605 may execute the computer readable program code. The communication hardware 615 may communicate with external devices such as the network 115 of FIG. 1.

FIG. 7 is a schematic block diagram illustrating one embodiment of a scheduling apparatus 700. The scheduling apparatus 700 may be embodied in the computer 600 of FIG. 6. The description of the scheduling apparatus 700 refers to elements of FIGS. 1-6, like numbers referring to like elements. The scheduling apparatus includes a management module 705 and a communication module 710. The management module 705 and the communication module 710 may be embodied in the computer readable program code. The computer readable program code may be stored in a memory 610 and executed by the processor 605.

The management module 705 may generate a business event 150 in response to receiving a scheduling event 125. The communication module 710 may communicate a worker request 155 to a worker contact address 110 of a worker profile 120 if the worker profile 120 matches the business event 150. In addition, the communication module 710 receives at least one bid 160 for the worker request 155 from the worker contact address 110 in response to the worker request 155.

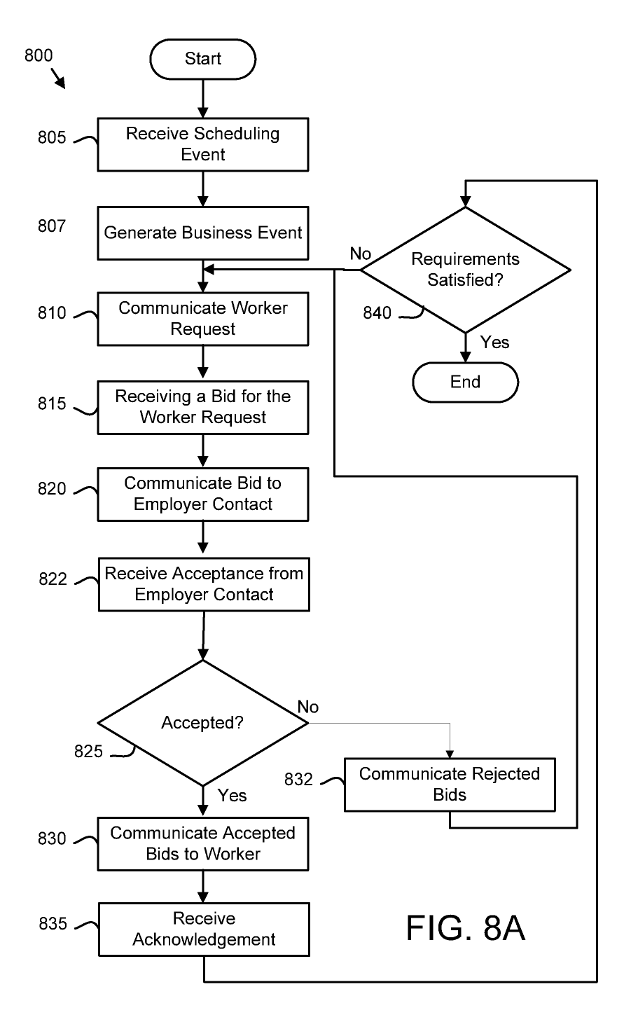

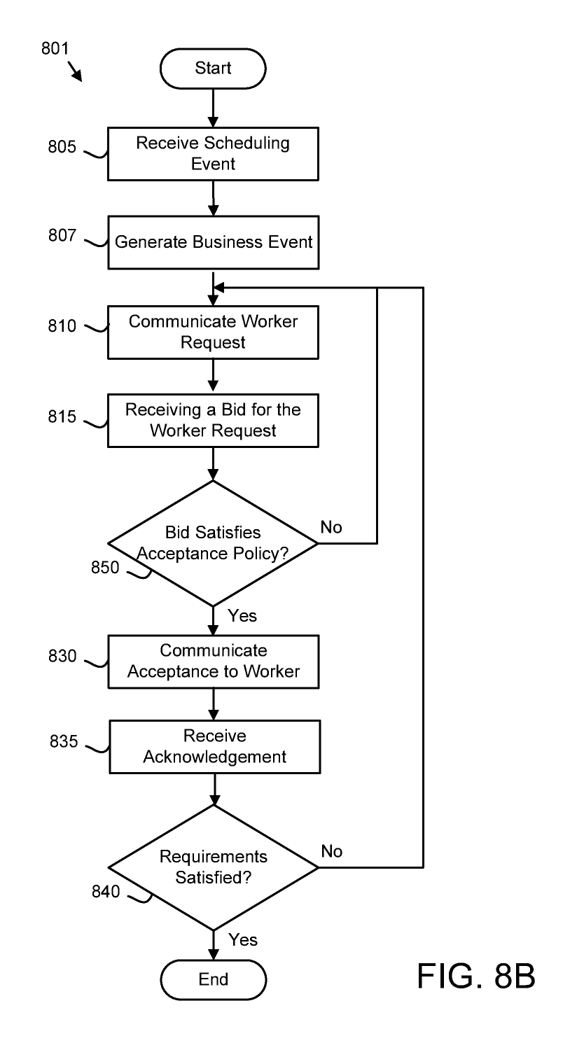

FIG. 8A is a schematic flow chart diagram illustrating one embodiment of a scheduling method 800. The method 800 performs the functions of the apparatus 700 of FIG. 7. The description of the method 800 refers to elements of FIGS. 1-7, like numbers referring to like elements. In one embodiment, the method 800 is performed by a computer readable storage medium, such as the memory 610. The computer readable storage medium may store computer readable program code that when executed by the processor 605 performs the functions of the method 800.

The method 800 starts, and in one embodiment the communication module 710 receives the scheduling event 125. In one embodiment, the scheduling event 125 comprises a removing of a first worker from a work schedule. The work schedule may list one or more workers and the times the workers are scheduled to perform business functions. For example, the work schedule may indicate the times that one or more receptionists, one or more dental hygienists, one or more assistants, or one or more dentists will perform business functions in a dental office.

In one embodiment, the scheduling event 125 comprises receiving an unable-to-work message from a first worker at the scheduling address 140. For example, a first worker that was previously scheduled on the work schedule to perform business functions may send the message to the scheduling address 140 that the first worker is unable to work at one or more scheduled times.

The scheduling event 125 may comprise a failure of the first worker to clock in before a specified clock-in time. For example, workers may clock in at a computer workstation at the beginning of a scheduled work time. If the first worker does not clock in before the specified clock-in time, the scheduling event 125 may be generated. In one embodiment, the specified clock-in time is in the range of 10 to 30 minutes after a start time for the first worker.

In one embodiment, the scheduling event 125 may comprise a request. A supervisor may issue the request directly to the scheduling system 105 and/or through the scheduling address 140. Alternatively, a worker may issue the request to the scheduling system 105 and/or through the scheduling address 140.

In one embodiment, the scheduling event 125 comprises not receiving a confirmation message prior to a specified confirmation time at the scheduling address 140. A first worker may send a confirmation message confirming that the first worker intends to work during a scheduled work time. The specified confirmation time may be in the range of 30 minutes to two hours prior to the start of a scheduled start time for the first worker. If the confirmation message is not received prior to the specified confirmation times, a scheduling event 125 may be generated.

The management module 705 generates 807 a business event 150 in response to receiving the scheduling event 125. In one embodiment, the management module 705 automatically generates 807 the business event 150. Alternatively, the management module 705 may communicate the scheduling event 125 to the employer contact address 115 and generate 807 the business event 150 in response to receiving a request authorization from the employer contact address 115.

The business event 150 may comprise the skill requirement 205 and the time requirement 230. In one embodiment, the skill requirement 205 is set equal to the worker skill 310 of the first worker that is unable to report for the scheduled work time. Alternatively, the skill requirement 205 of the business event 150 is set to a skill requirement for a specified position. The time requirement 230 may be set to the scheduled work time of the first worker. Alternatively, the time requirement 230 may be set to all unassigned time intervals in the work schedule.

The communication module 710 communicates 810 the worker request 155 to the worker contact address 110 of at least one worker profile 120 if the at least one worker profile 120 matches the business event 150. A worker profile 120 may match the business event 150 if the worker skill 310 satisfies the skill requirement 205. In one embodiment, the worker skill 310 satisfies the skill requirement 205 if each element of the worker skill 310 is equal to and/or exceeds each element of the skill requirement 205. Alternatively, a skill match score m is calculated for the worker skill 310, where each kᵢ is a non-zero constant and each xᵢ is a skill requirement element and each yᵢ is a work skill element for each ith skill element.

m=Σkᵢ*(xᵢ−yᵢ) Equation 1

In one embodiment, the worker request 155 may be communicated 810 to the worker contact address 110 of each worker profile 120 where the match score of the worker profile 120 exceeds a skill match threshold.

In one embodiment, the worker request 155 is communicated 810 to the worker contact address 110 of each worker profile 120 where the worker available times 315 matches a least a portion of the time requirement 230. In one embodiment, the worker available times 315 match at least a portion of the time requirement 230 if an employer location 215 is within a first worker geographic area 320a and if the worker available times 315 comprises a first time interval 210a of the time requirement 230.

The management module 705 may rank the worker profiles 120 that match the business event 150. In one embodiment, worker profiles 120 that completely satisfied a skill requirement 205 are ranked first. In an alternate embodiment, the worker profiles 120 that completely satisfy the time requirement 230 are ranked first. In one embodiment, a rank scorer is calculated for each worker profile 120 using equation 2, where each h is a non-zero constant, s is a percentage of the skill requirement 205 fulfilled by the worker skill 310, t is a percentage of the time requirement 230 fulfilled by the worker available times 315 and the worker geographic area 320, and l is the availability likelihood 325.

r=h₁*s+h₂*t+h₃*l Equation 2

The communication module 710 may communicate 810 the worker request 155 to one or more worker contact addresses 110. The ranking may favor worker profiles 120 with a high availability likelihood 325. Alternatively, the ranking may favor worker profiles 120 with a strong match between the time requirement 230 and the worker available times 315. In a certain embodiment, the ranking may favor worker profiles 120 where the worker skill 310 completely satisfies the skill requirement 205. The communication module 710 may stagger the communication 810 of the worker requests 155, sending the worker request 155 to the higher-ranked worker profiles 120 before sending the worker request 155 to the lower-ranked worker profiles.

In one embodiment, the worker contact address 110 comprises a plurality of addresses including a least one preferred address. The worker request 155 may be communicated to the preferred address. Alternatively, the worker request 155 may be communicated to each of the plurality of addresses for the worker contact address 110.

For example, the communication module 710 may communicate 810 SMS messages comprising the worker request 155 to two worker contact addresses 810 and communicate 810 an e-mail comprising the worker request 155 to another worker contact address 810. Workers may view the worker request 155 at the worker contact addresses 110 and if a first worker is interested in the worker request 155, the first worker may respond by communicating a bid 160 to the scheduling address 140.

In one embodiment, the electronic device hosting the worker contact address 110 may execute a specified application that receives the worker request 155 and communicates the bid 160 in response to the worker request 155. The specified application may display the employer contact address 115, the skill requirement 205, the time requirement 230, the offered compensation 220, and the requested expiration 410. In one embodiment, the specified application integrates the time requirement 230 with a personal calendar for the worker. The specified application may allow the worker to enter the worker committed times 505, including an acceptance of all the time requirements 230, and the bid expiration 510 for the bid 160. In addition, the worker may specify a counter offer 515 through the specified application.

In an alternate embodiment, the electronic device receives the worker request 155 as a text message. The text message may include the employer contact address 115, the skill requirement 205, the time requirement 230, to request expiration 410, and the offered compensation 220. The worker may respond with an acceptance of the time requirement 230 as the worker committed times 505, specified time intervals and locations as the worker committed times 505, a date and/or time for the bid expiration 510, and the value for the counter offer 515 by replying to the worker request 155. The reply message may be the bid 160.

The communication module 710 receives 815 at least one bid 160 for the worker request 155 at the scheduling address 140 from the worker contact addresses 110 in response to the worker request 155. If the bid 160 is a text message, the management module 710 may parse the text message to retrieve the worker contact address 110, the worker committed times 505, the bid expiration 510, and the counter offer 515.

The communication module 710 may communicate 820 the bid 160 to the employer contact address 115. In one embodiment, a plurality of bids 160 are communicated 822 the employer contact address 115. The electronic device hosting the employer contact address 115 may present as the bid 160 to the employer and receive an employer response using a specified employer application. Alternatively, the electronic device hosting the employer contact address 115 may present the bid 160 as a text message and receive the employer response as a reply.

The employer response may accept one or more bids 160 as accepted bids 165. Bids 160 that are not accepted are rejected bids 180. In one embodiment, rejected bids 180 may include a modified worker request 155. For example, the employer may modify the terms of the worker request 155 as part of the rejected bid 180. The accepted bids 165 and the rejected bids 180 may comprise the acceptance 145. In one embodiment, the acceptance 145 comprises either one accepted bid 165 or one rejected bid 180.

The communication module 710 may further receive 822 the acceptance 145 from the employer contact address 115. The management module 705 may enter the worker committed times 505 for each accepted bid 165 into the work schedule. If a bid 160 in the acceptance 145 is an accepted bid 165, the communication module 710 communicates 830 the accepted bid 165 to the worker contact address 110 of the accepted bid 165. If the bid 160 in the acceptance 145 is a rejected bid 180, the communication module communicates 832 the rejected bid 180 to the worker contact address 110 of the rejected bid 180 and may communicate 810 an additional worker request 155. In one embodiment, the additional worker request 155 is the modified worker request 155 and is directed to the worker contact address 110 of the rejected bid 180.

In one embodiment, the communication module 710 receives 835 the acknowledgment 170 from the worker contact address 110 corresponding to each accepted bid 165. The management module 705 may enter the worker committed times 505 from the accepted bid 165 into the work schedule in response to receiving the acknowledgement 170.

In one embodiment, the management module 705 determines 840 if the skill requirement 205 and the time requirement 230 for the business event 150 are satisfied. If the skill requirement 205 and the time requirement 230 are not completely satisfied, the communication module 710 continues to communicate 810 worker requests 155 and/or wait to receive 815 additional bids 160. If the skill requirement 205 and the time requirement 230 are completely satisfied, the method 800 ends.

FIG. 8B is a schematic flow chart diagram illustrating alternate embodiment of a scheduling method 801. The method 801 is an alternative embodiment of the scheduling method 800 of FIG. 8A. The description of the method 801 refers to elements of FIGS. 1-8A, like numbers referring to like elements. In one embodiment, the method 801 is performed by a computer readable storage medium, such as the memory 610. The computer readable storage medium may store computer readable program code that when executed by the processor 605 performs the functions of the method 801.

In one embodiment, the method 801 performs steps 805, 807, 810, 815, 830, 835, and 840 as described for FIG. 8A. In response to receiving 815 a bid 160 for the worker request 155, the management module 705 determines 850 if the bid 160 satisfies the acceptance policy 135. If the bid 160 satisfies the acceptance policy 135, the bid is the accepted bid 165.

In one embodiment, the accepted bid 165 satisfies the acceptance policy 135 by completely fulfilling the time requirement 230 and the skill requirements 205. Alternatively, the accepted bid 165 satisfies the acceptance policy 135 by fulfilling the skill requirement 205 and a least a portion of the time requirement 230. The acceptance policy 135 is described hereafter in more detail.

If the bid 160 satisfies the acceptance policy 135, the communication module 710 communicates 830 the acceptance 145 to the worker contact address 110 as described above. If the bid 160 does not satisfy the acceptance policy 135, the communication module 710 may communicate 810 another worker request 155 and/or wait to receive 815 a bid 160. Thus the method 801 automatically determines whether to accept or reject a bid 160. As a result, the method 801 may schedule workers unsupervised by the employer and/or an administrator. The automatic scheduling of workers may greatly speed scheduling to satisfy the business event 150.

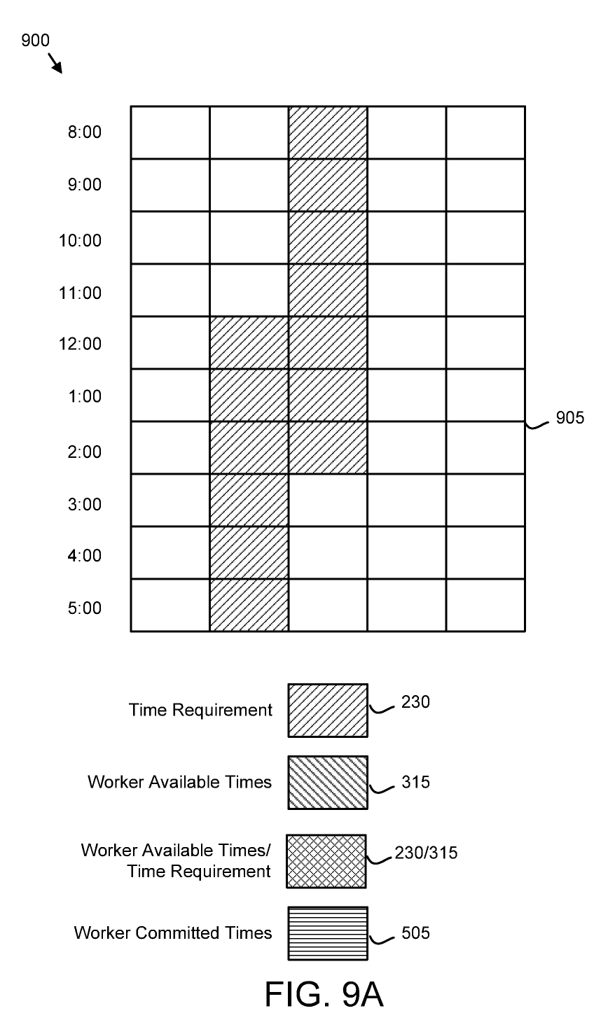

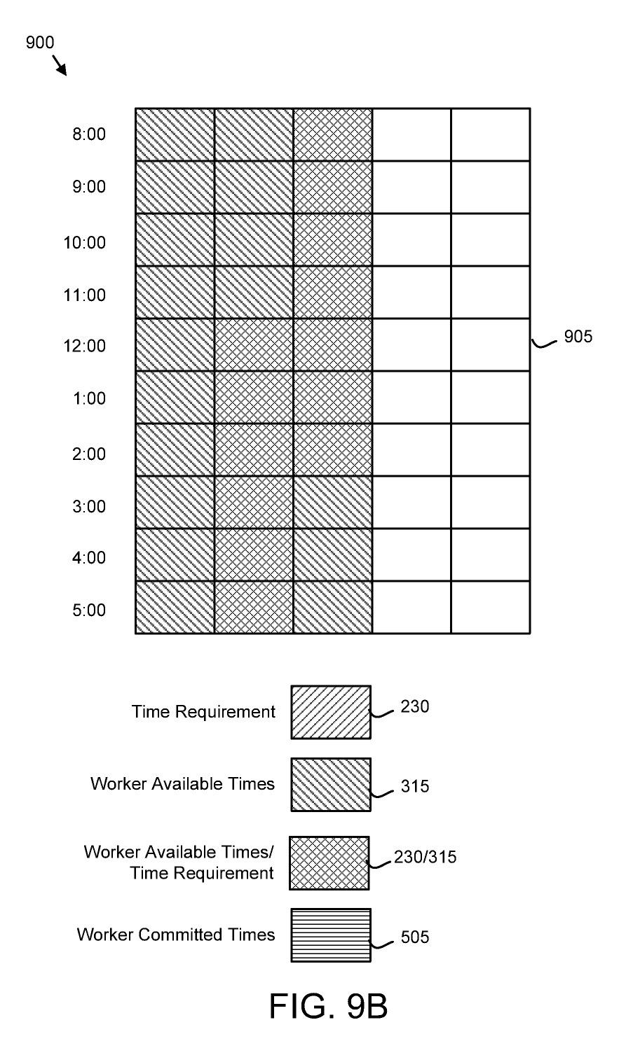

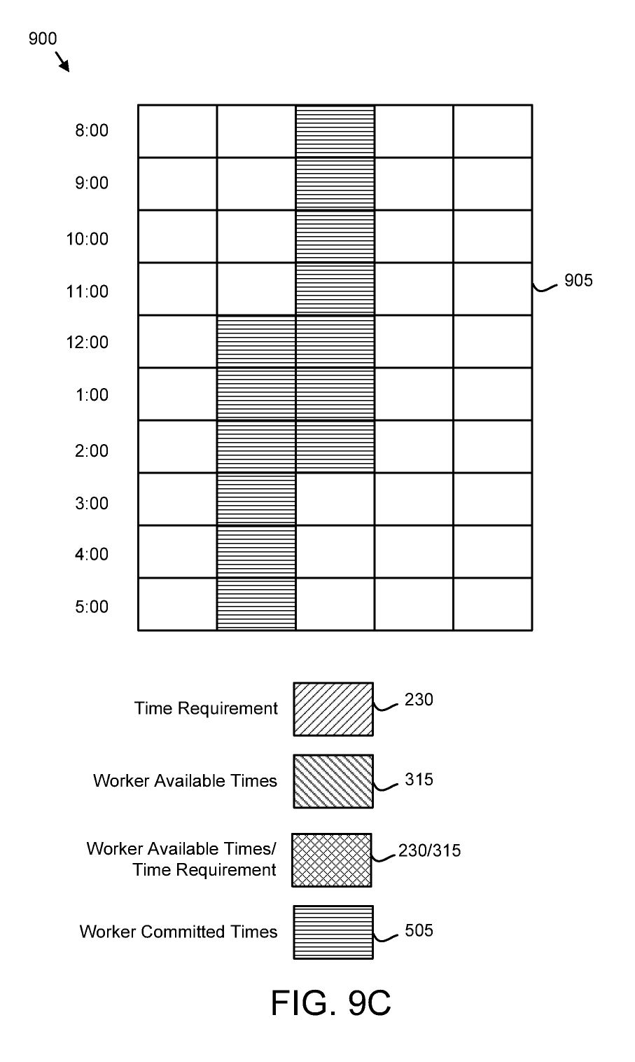

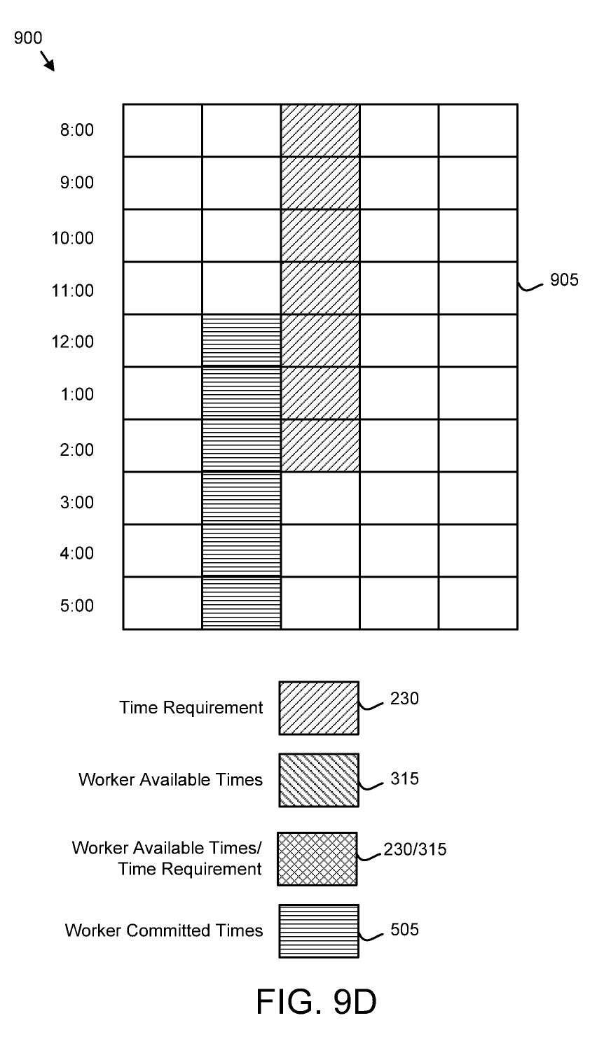

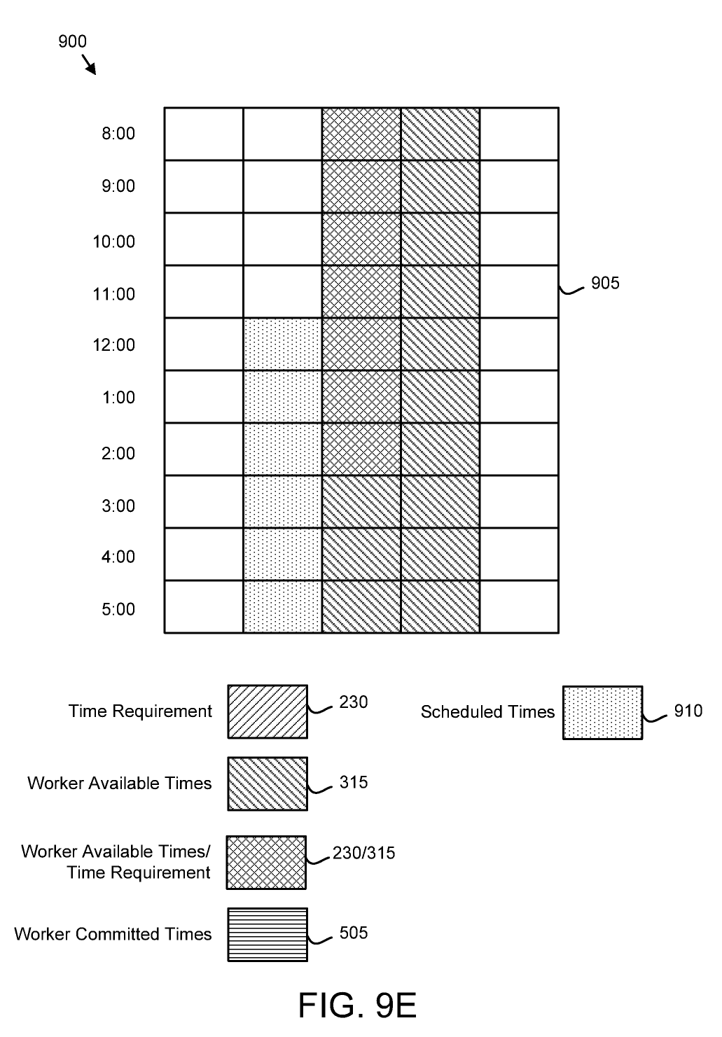

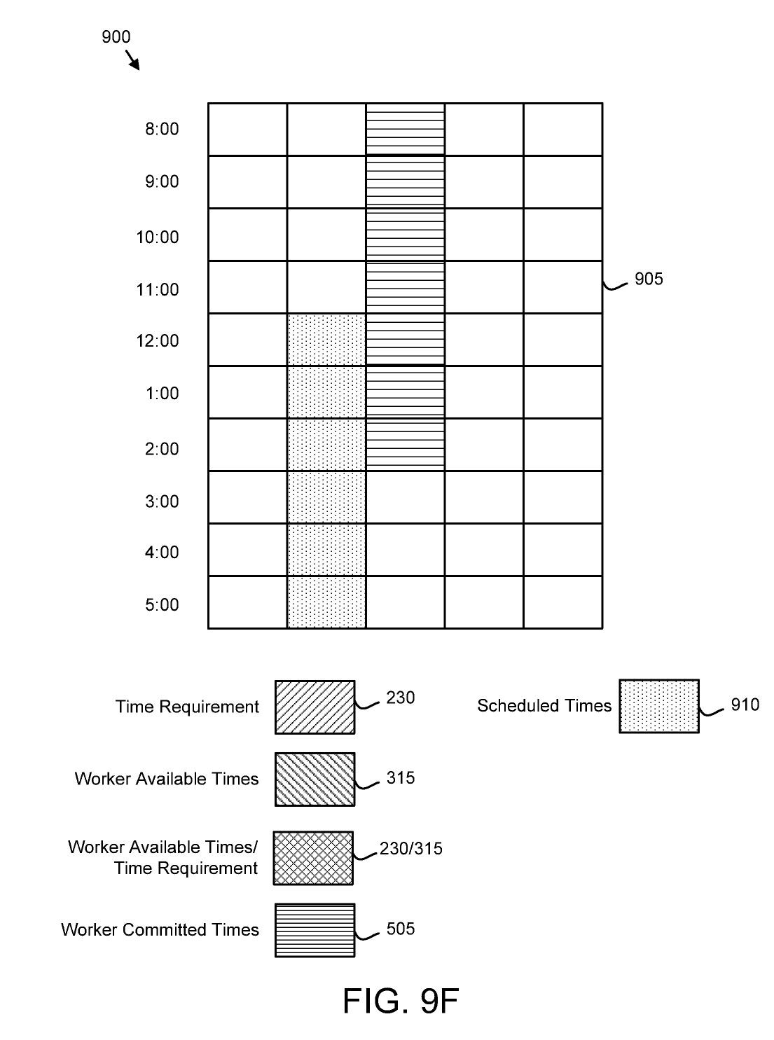

FIGS. 9A-F are schematic block diagrams illustrating one embodiment of a scheduling cycle 900. The cycle 900 is a prophetic example of the function of the embodiments described in FIGS. 1-8B. The description of the cycle 900 refers to elements of FIGS. 1-8B, like numbers referring to like elements. One of skill the art will recognize that the embodiments may be practiced with full hours, portions of hours, full workdays, portions of workdays, full workweeks, portions of work weeks, full work months, portions of work months, and combinations thereof.

A work schedule 905 is depicted for a work week, although any other work period may be employed. A time requirement 230 from a business event 150 is plotted in the work schedule 905. The time requirement 230 may be for a single employer location 215. Alternatively, the time requirement 230 may comprise two or more time intervals 210. Each time interval may specify a unique employer location 215.

FIG. 9B shows the work schedule 905 of FIG. 9A with the time requirement 230 and the worker available times 315 from a first worker profile 120 shown. In one embodiment, a worker request 155 may be sent to the first worker contact address 110 of the first worker profile 120 if the worker skill 310 satisfies the skill requirement 205 because the worker available times 315 completely satisfies the time requirement 230.

FIG. 9C shows the work schedule 905 of FIGS. 9A-B. The scheduling system 105 has received a first bid 160 from the first worker contact address 110. The worker committed times 505 of the first bid 160 are shown. The first bid 160 may be accepted because the first bid 160 satisfies the acceptance policy 135.

FIG. 9D shows the work schedule 905 of FIG. 9A. The scheduling system 105 has received a second bid 160 from a second worker contact address 110. However, in this prophetic example, the worker committed times 505 do not completely satisfied the acceptance policy 135 because the worker committed times 505 do not satisfy all of the time requirement 230. The acceptance policy 135 may reject the second bid 160. Alternatively, the acceptance policy 135 may accept the second bid 160. In addition, the scheduling system 105 may continue to communicate 810 worker requests 115 and receive 815 bids 160 until the time requirement 230 and the skill requirement 205 are completely satisfied.

FIG. 9E shows the work schedule 905 of FIG. 9D with the worker available times 315 for a prophetic third worker profile 120 shown. The portion of the time requirement 230 satisfied in FIG. 9D is shown as scheduled time 910. Because the time requirement 230 is not completely satisfied, the scheduling system 105 may communicate 810 a worker request 155 to the worker contact address 110 of the third worker profile 120.

FIG. 9F shows the work schedule 905 of FIG. 9E with the worker committed times 505 of a third bid 160 from the worker contact address 110 on a third worker profile 120 shown. If the third bid 160 is accepted, the prophetic time requirement 230 may be completely satisfied.

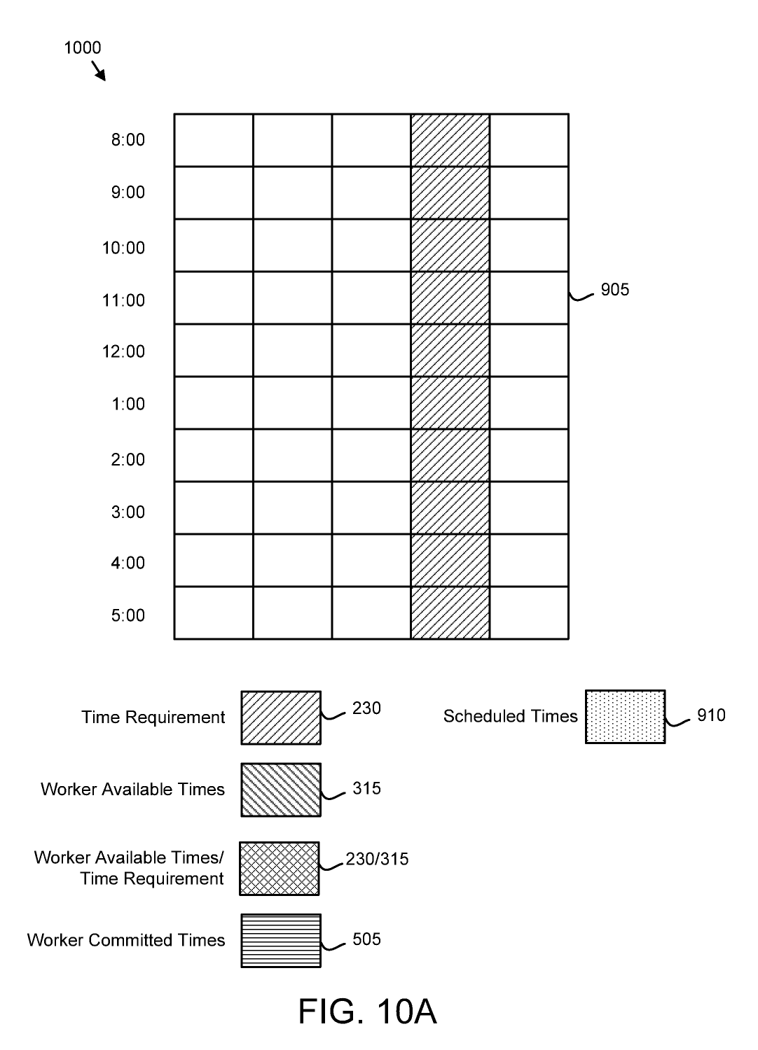

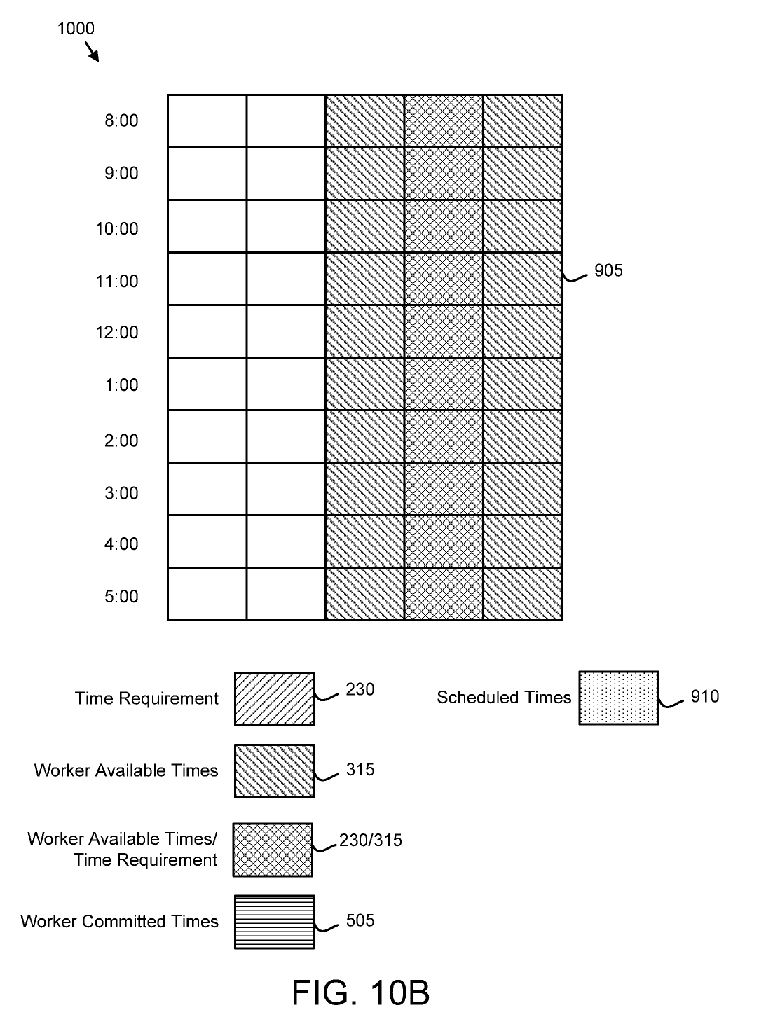

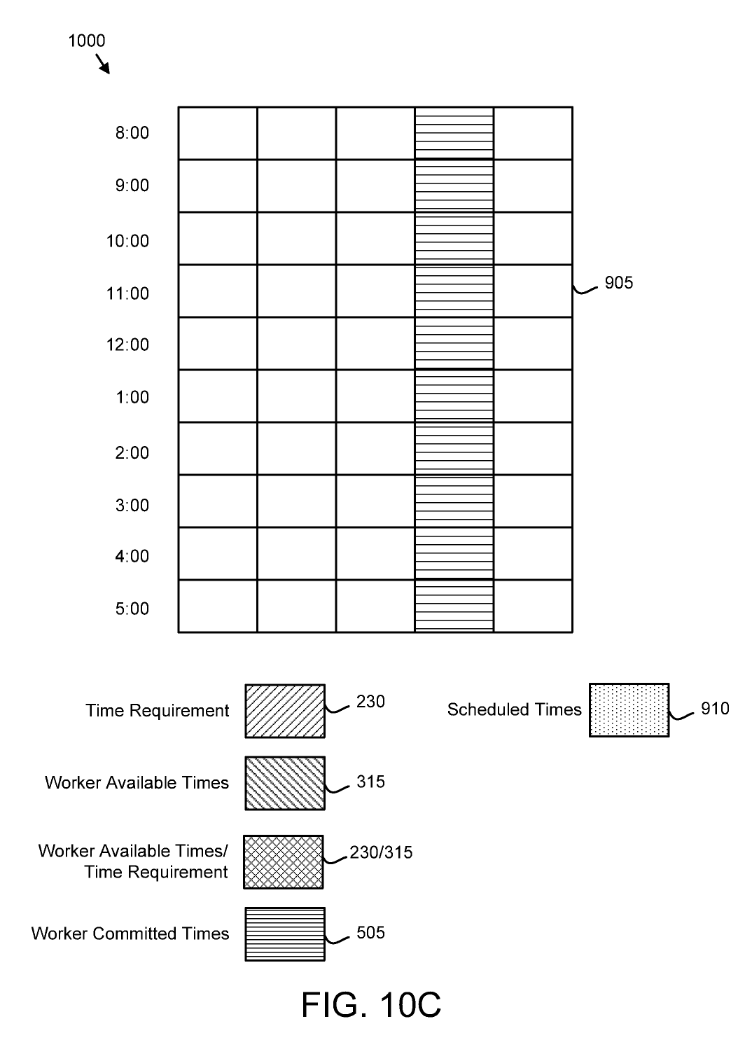

FIGS. 10A-C are schematic block diagrams illustrating one alternate embodiment of a scheduling cycle 1000. The cycle 1000 is a prophetic example of the function of the embodiments described in FIGS. 1-8B. The description of the cycle 1000 refers to elements of FIGS. 1-9F, like numbers referring to like elements. One of skill the art will recognize that the embodiments may be practiced with full hours, portions of hours, full workdays, portions of workdays, full workweeks, portions of work weeks, full work months, portions of work months, and combinations thereof.

A time requirement 230 from a business event 150 is plotted in the work schedule 905. The time requirement 230 may be for a single employer location 215. Alternatively, the time requirement 230 may comprise two or more time intervals 210. Each time interval may specify a unique employer location 215.

FIG. 10B shows the work schedule 905 of FIG. 10A with the time requirement 230 and the worker available times 315 from a first worker profile 120. In one embodiment, a worker request 155 may be sent to the first worker contact address 110 of the first worker profile 120 if the worker skill 310 satisfies the skill requirement 205 because the worker available times 315 completely satisfies the time requirement 230.

FIG. 10C shows the work schedule 905 of FIGS. 10A-B. The scheduling system 105 has received a first bid 160 from the first worker contact address 110. The worker committed times 505 of the first bid 160 are shown. The first bid 160 may be accepted because the first bid 160 satisfies the acceptance policy 135. Thus the embodiments described herein may automatically schedule a worker with the skill requirement 205 and the time requirement 230. In addition, worker requests 155 may automatically be communicated 810 to the worker contact addresses 110 of a plurality of worker profiles 120 and multiple bids 160 considered.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for scheduling workers comprising:
generating, by use of a processor, a business event in response to receiving a scheduling event, the business event comprising a skill requirement and a time requirement;
communicating a worker request to a worker contact address of a worker profile if the worker profile matches the business event, the worker request comprising the skill requirement, the time requirement, and an offered compensation, wherein the worker profile comprises the worker contact address, a worker skill, worker available times, and a worker geographic area, and the time requirement comprises an employer location, and wherein the worker profile matches the worker request if the worker profile has a highest rank score r, calculated as r=h1*s+h2*t+h3*l where h1, h2, and h3 are non-zero constants, s is a percentage of the skill requirement fulfilled by the worker skill, t is a percentage of the time requirement fulfilled by the worker available times and the worker geographic area, and l is an availability likelihood; and
receiving at a first bid for the worker request from worker contact address in response to the worker request, the first bid comprising a counter offer;
communicating a rejection to the worker contact address in response to the counter offer exceeding the offered compensation, the rejection comprising an additional worker request;
receiving a second bid from the worker contact address in response to the rejection;
communicating a second acceptance of the second bid to the worker contact address in response to the second bid satisfying an acceptance policy by fulfilling a first occurring unfilled portion of the time requirement and the additional worker request; and
receiving a second acknowledgement from the worker contact address corresponding to the accepted second bid.

2. (canceled)

3. (canceled)

4. (canceled)

5. The method of claim 1, wherein at least two bids from two worker contact addresses satisfy the acceptance policy if the at least two bids combine to satisfy the time requirement and the skill requirement.

6. The method of claim 1, the method further comprising:
communicating the first bid to an employer contact address;
receiving a first acceptance of the first bid from the employer contact address;
communicating the first acceptance to the worker contact address corresponding to the accepted first bid; and
receiving a first acknowledgement from the worker contract address corresponding to the accepted first bid.

7. (canceled)

8. (canceled)

9. (canceled)

10. (canceled)

11. The method of claim 1, wherein the worker geographic area is selected from the group consisting of a specified distance from a worker location and an area served by at least one specified postal code.

12. The method of claim 1, wherein the time requirement comprises at least two time intervals and each time interval is associated with a unique employer location.

13. The method of claim 1, wherein the time requirement is a fractional portion of a work period, the work period selected from the group consisting of at least one work day, at least one work week, and at least one work month.

14. The method of claim 1, wherein the scheduling event comprises a removing of a first worker from a work schedule.

15. The method of claim 1, wherein the scheduling event comprises receiving an unable-to-work message from a first worker at a scheduling address.

16. The method of claim 1, wherein the scheduling event comprises a failure of a first worker to clock in before a specified clock-in time.

17. The method of claim 1, wherein the scheduling event comprises not receiving a confirmation message prior to a specified confirmation time at a scheduling address.

18. The method of claim 1, wherein the scheduling event is received at a scheduling address and communications are through a channel comprising at least one of an Internet channel, a Short Message Service (SMS) channel, a telephonic channel, a mobile telephone channel, and an email channel.

19. An apparatus comprising:
a computer readable storage medium storing computer readable program code executable by a processor, the computer readable program code comprising:
a management module generating a business event in response to receiving a scheduling event, the business event comprising a skill requirement and a time requirement; and
a communication module communicating a worker request to a worker contact address of a worker profile if the worker profile matches the business event, the worker request comprising the skill requirement, the time requirement, and an offered compensation, wherein the worker profile comprises the worker contact address, a worker skill, worker available times, and a worker geographic area and the time requirement comprises an employer location, and wherein the worker profile matches the worker request if the worker profile has a highest rank score r, calculated as r=h1*s+h2*t+h3*l where h1, h2, and h3 are non-zero constants, s is a percentage of the skill requirement fulfilled by the worker skill, t is a percentage of the time requirement fulfilled by the worker available times and the worker geographic area, and l is an availability likelihood;
the communication module receiving a first bid for the worker request from the worker contact address in response to the worker request, the first bid comprising a counter offer, communicating a rejection to the worker contact address in response to the counter offer exceeding the offered compensation, the rejection comprising an additional worker request, receiving a second bid from the worker contact address in response to the rejection, communicating an acceptance of the second bid to the worker contact address in response to the second bid satisfying an acceptance policy by fulfilling a first occurring unfilled portion of the time requirement and the additional worker request, and receiving an acknowledgement from the worker contact address corresponding to the accepted second bid.

20. A computer program product for scheduling workers, the computer program product comprising:
a computer readable storage medium having computer readable program code embodied therein, the computer readable program code configured to:
generate a business event in response to receiving a scheduling event, the business event comprising a skill requirement and a time requirement;
communicate a worker request to a worker contact address of a worker profile if the worker profile matches the business event, the worker request comprising the skill requirement, the time requirement, and an offered compensation, wherein the worker profile comprises the worker contact address, a worker skill, worker available times, and a worker geographic area and the time requirement comprises an employer location, and wherein the worker profile matches the worker request if the worker profile has a highest rank score r, calculated as r=h1*s+h2*t+h3*l where h1, h2, and h3 are non-zero constants, s is a percentage of the skill requirement fulfilled by the worker skill, t is a percentage of the time requirement fulfilled by the worker available times and the worker geographic area, and l is an availability likelihood;
receive a first bid for the worker request from the worker contact address in response to the worker request, the first bid comprising a counter offer;
communicating a rejection to the worker contact address in response to the counter offer exceeding the offered compensation, the rejection comprising an additional worker request;
receiving a second bid from the worker contact address in response to the rejection;
communicating an acceptance of the second bid to the worker contact address in response to the second bid satisfying an acceptance policy by fulfilling a first occurring unfilled portion of the time requirement and the additional worker request; and
receiving an acknowledgement from the worker contact address corresponding to the accepted second bid.
